(19) United States
(12) Patent Application Publication
(10) Pub. No.: US 2019/0360426 A1
(43) Pub. Date: Nov. 28, 2019

(54) CYLINDER LINERS COMPRISING INDUCTION COILS AND HYBRID INTERNAL COMBUSTION ENGINES AND POWERTRAINS UTILIZING THE SAME

(71) Applicant: GM GLOBAL TECHNOLOGY OPERATIONS LLC, Detroit, MI (US)

(72) Inventor: Angelo Cancellieri, Torino (IT)

(21) Appl. No.: 15/988,038

(22) Filed: May 24, 2018

(51) Int. Cl. F02F 1/00; F02B 63/04; B60K 6/26; H02K 35/02; H02K 7/18; B60L 11/14

(52) U.S. Cl. CPC F02F 1/004; F02B 63/041; B60K 6/26; B60L 2220/12; H02K 7/1876; B60L 11/14; H02K 35/02

(57) ABSTRACT

A hybrid internal combustion engine (HICE) comprises an engine block defining one or more cylinder bores, a cylinder liner disposed within each of the one or more cylinder bores, and a piston comprising a permanent magnet. Each cylinder liner comprises a non-ferromagnetic material and an induction coil encased within the non-ferromagnetic material. The permanent magnet of each piston can be reciprocated via electrical power received by an appurtenant induction coil or repeatedly transported across the height of the induction coil to generate electrical energy. A hybrid powertrain of a vehicle includes a HICE, an electrical energy storage device, and a power electronics module configured to transfer the generated electrical energy between each of the one or more cylinder liners and the energy storage device. A motor/generator engaged with a wheel can drive the wheel or generate power via braking thereof.

### INTRODUCTION

During a combustion cycle of an internal combustion engine (ICE), air/fuel mixtures are provided to cylinders within an engine block of the ICE. The air/fuel mixtures are compressed and/or ignited and combusted to provide output torque via reciprocating pistons positioned within the cylinders.

### SUMMARY

A cylinder liner for a hybrid internal combustion engine (HICE) is provided and includes a tubular body of a non-ferromagnetic material having a height, a thickness defined by an inner diameter and an outer diameter, and an outer contour configured to correspond to the inner contour of an engine block cylinder bore, and an induction coil encased within the non-ferromagnetic material between the inner diameter and the outer diameter of the tubular body. The non-ferromagnetic material can be a ceramic material. The ceramic material can be a ceria-stabilized zirconia. The non-ferromagnetic material in direct contact with the induction coil can be non-electrically conductive.

A hybrid internal combustion engine (HICE) is provided and includes an engine block defining one or more cylinder bores, a cylinder liner disposed within each of the one or more cylinder bores, and a piston having a head disposed within each of the one or more cylinder liners and including a permanent magnet. Each cylinder liner can include a tubular body of a non-ferromagnetic material having a height and a thickness defined by an inner wall and an outer wall, wherein the outer wall forms a contour configured to correspond to an inner contour of its respective cylinder bore, and an induction coil encased within the non-ferromagnetic material between the inner wall and the outer wall of the tubular body. The non-ferromagnetic material can be a ceramic material. Combustion can occur in each cylinder at least partially within the volume defined the induction coil thereof. Each of the one or more pistons can be coupled to a crankshaft. The height of the induction coil can extend above a top dead center position of the permanent magnet and below a bottom dead center position of the permanent magnet. The HICE could have been converted from an internal combustion engine by introducing each of the one or more cylinder liners into one or more of the cylinder bores. Each piston can be reciprocated within its appurtenant cylinder via electrical power received by the induction coil appurtenant to each cylinder. Combustion-induced reciprocation of each piston head can repeatedly transport its permanent magnet across at least a portion of the height of the induction coil of the appurtenant cylinder liner and generates electrical energy. The position of a piston within a cylinder can be determined based on an electrical signal generated by the induction coil. The HICE can be started by delivering electrical power to each of the induction coils.

A hybrid powertrain of a vehicle is provided and includes an electrical energy storage device and a hybrid internal combustion engine (HICE). The HICE can include an engine block defining one or more cylinder bores, a cylinder liner disposed within each of the one or more cylinder bores and a piston having a head disposed within each of the one or more cylinder liners and including a permanent magnet. Each cylinder liner can include a tubular body of a non-ferromagnetic material having a height and a thickness defined by an inner wall and an outer wall, wherein the outer wall forms a contour configured to correspond to an inner contour of its respective cylinder bore, and an induction coil encased within the non-ferromagnetic material between the inner wall and the outer wall of the tubular body. Combustion-induced reciprocation of the piston head can repeatedly transport the permanent magnet across at least a portion of the height of the induction coil and generates electrical energy. The hybrid powertrain can further include a power electronics module configured to transfer the generated electrical energy between each of the one or more cylinder liners and the energy storage device. The hybrid powertrain can further include a motor/generator electrically connected to the power electronics module and configured to (1) convert electrical power received from the power electronics module to mechanical power in the form of tractive torque that drives one or more wheels, and (2) generate electrical power from wheel braking. Each piston can be reciprocated within its appurtenant cylinder via electrical power received by the induction coil appurtenant to each cylinder from the electrical energy storage device. The power electronics module can include one or more controllable power inverters configured to transform electric power between alternating electrical current and direct electrical current. The hybrid powertrain can further include a crankshaft mechanically coupled to each of the one or more pistons and capable of translating the reciprocating movement of the one or more pistons to rotational motion. The hybrid powertrain can further include a HICE heater system including a resistor capable of receiving electrical power, converting the electrical power to heat, and transferring the heat to a coolant which circulates through one or more aspects of the HICE.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 illustrates a cross-sectional side view of a hybrid internal combustion engine, according to one or more embodiments.

FIG. 2 illustrates a schematic of a hybrid powertrain, according to one or more embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Provided herein are hybrid internal combustion engines (HICE) which incorporate aspects of an internal combustion engine (ICE) and a linear alternator generator. The HICEs disclosed herein uniquely provide combustion chambers disposed within the volumes defined by induction coils of the linear alternator generators. The HICEs disclosed herein simplify hybrid powertrains, improve various performance aspects of ICE and hybrid vehicles, and lend additional advantageous previously unavailable to traditional ICE and hybrid vehicles.

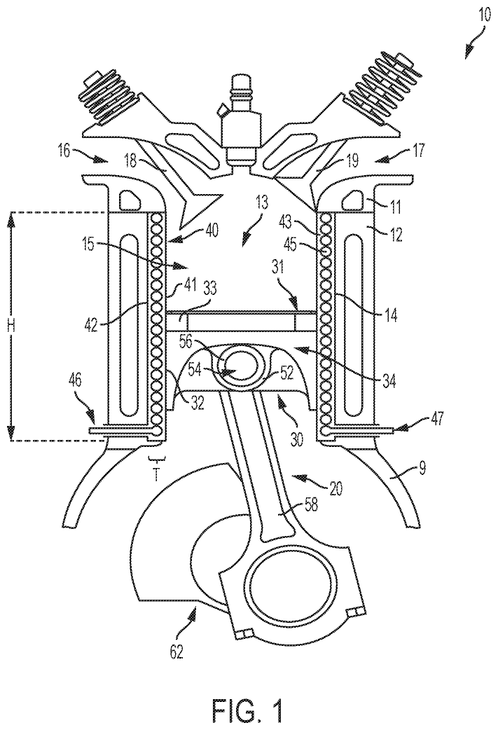

FIG. 1 illustrates a cross-sectional side view of a HICE 10, which includes an engine block 12 defining a plurality of cylinder bores 13, wherein each cylinder bore 13 has a continuous cylinder wall 14, which is typically a cylindrical wall. A cylinder liner 40 is disposed within the cylinder bore 13 and comprises a generally tubular body 43 have a height H and a thickness T. Thickness T is defined by an inner wall 41 and an outer wall 42, wherein the inner wall 41 defines an inner contour and the outer wall 42 defines an outer contour configured to correspond to the contour of cylinder wall 14. Cylinder liner 40 further comprises an induction coil 45 encased within the tubular body 43 between the inner wall 41 and the outer wall 42. Induction coil 45 winds concentrically across at least a portion of the height H of the cylinder liner 40. The induction coil 45 can further comprise a first plug 46 and a second plug 47 which can electrically couple the induction coil 45 to various other components as will be described below. The induction coil can comprise copper, or other conductive materials with ideally low resistivity, such as aluminum, silver, and tungsten. In one embodiment, the induction coil 45 diameter comprises about 5 mm, and the cylinder liner 40 thickness H is about 5.2 mm to about 7 mm. The induction coil 45 may comprise a plurality of turns and poles.

Only one cylinder bore 13 and appurtenant cylinder liner 40 is shown and described for the purpose of clarity, although in other embodiments the HICE 10 may comprise a plurality of cylinder bores 13 and appurtenant cylinder liners 40 in various configurations as are known in the art. Closing one end of the cylinder bore 13 is a cylinder head 11, which cooperates with a top surface 31 of a piston 20 to define a variable volume combustion chamber 15. The cylinder head 11 defines intake and exhaust ports 16 and 17, respectively, which are selectively opened by valves, such as poppet valves 18 and 19, respectively. The intake and exhaust ports 16 and 17 are provided in selective communication with the combustion chamber 15 to provide for the introduction of air or an air-fuel mixture into the combustion chamber 15 and the exhaust of products of combustion from the combustion chamber 15.

Piston head 30 is defined by the top surface 31 and a circumferential side surface which extends downward from top surface 31 and generally defines a cylindrical piston skirt 32. Piston head 30 may be non-cylindrical in some embodiments, so long as the top surface 31 generally corresponds to the cross-sectional geometry (i.e., inner contour) of cylinder liner 40. Piston head 30 can further include a pin boss portion 52 which extends downward from top surface 31 within a bottom cavity define by the piston skirt 32. Piston head 30 further requires a permanent magnet 33, which occurs in one or more regions of piston head 30. For example, permanent magnet may comprise ring proximate top surface 31 (as shown), or may occur near the circumferential side surface and form a portion, or all of, piston skirt 32. The permanent magnet 33 can comprise multiple poles, in some embodiments. The permanent magnet 33 can comprise any ferrimagnetic material with a I_{curie} greater than the piston head 30 maximum temperature, such that the magnetic 33 properties of the permanent magnet 33 are not diminished during operation of the HICE 10. In one embodiment, the permanent magnet comprises AlNiCo.

Piston 20 is configured to reciprocate within the cylinder bore 13 via the combustion of fuel in combustion chamber 15, and piston head 30 is engageable with the cylinder liner 40 inner wall 41 during its reciprocating motion. The piston top surface 31 forms one wall of the combustion chamber 15 that, upon movement of the piston 20, causes the expansion or contraction of the combustion chamber 15 as is required for operation in an internal combustion engine working cycle. To utilize piston 20 as a means for developing power, piston 20 is operatively engaged with external elements, such as a crankshaft 62 of a vehicle. Crankshaft 62 can translate reciprocating movement of one or more pistons 20 to rotational motion and translate the latter to one or more wheels of a vehicle drivetrain, for example. A crankcase 9 may enclose all or a portion of crankshaft 62 against the engine block 12. Crankshaft 62 can be operatively coupled to one or more pistons 20 via one or more respective connecting rods 58; each connecting rod 58 can couple to a piston pin bore 54 of a pin boss 52 via a piston pin 56, for example. In some embodiments, piston pin bore 54 can be formed in one or more places through the piston skirt 32. In such an embodiment, the pin boss 52 can be an optional feature.

The cylinder liner 40 tubular body 43 comprises a non-ferromagnetic material. The cylinder liner 40 tubular body 43 which is directly in contact with the induction coil 45 further comprises a non-conductive, dielectric material. The non-ferromagnetic material can comprise a ceramic material, such as ceria stabilized zirconia. During the combustion-induced reciprocation of piston head 30, the permanent magnet 33 is repeatedly transported across at least a portion of the height of the induction coil 45. During such movement, the permanent magnet 33 forms and breaks magnetic fields with the electrical coils and generates electrical energy per known electromagnetic principles. Generally, the combustion chamber 15 (and the combustion of fuel itself) of each cylinder occurs at least partially within the volume defined by the induction coil 45 thereof. In one embodiment, in order to maximize efficiency, the height of the induction coil 45 extends above a top dead center position of the permanent magnet 33 and below a bottom dead center position of the permanent magnet 33.

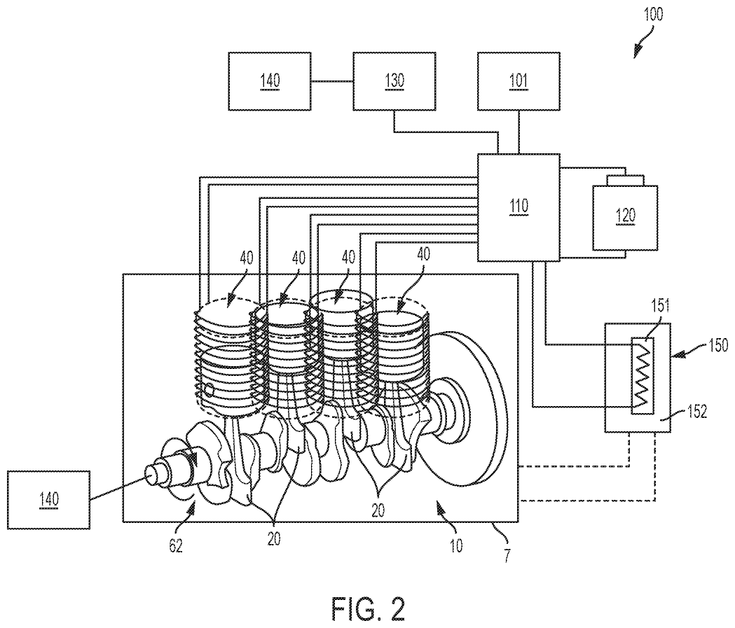

FIG. 2 illustrates a schematic of a hybrid powertrain 100, for example as utilized by a vehicle. Hybrid powertrain 100 comprises a HICE 10 (engine block 12 and other components omitted for clarity) which includes four cylinders, each with an appurtenant cylinder liner 40 in which an appurtenant piston 20 may reciprocate. Hybrid powertrain 100 further comprises a power electronics module (PEM) 110 electrically connected to the HICE 10, an energy storage device (ESD) 120 electrically connected to the PEM 110, and a motor/generator 130 connected to the PEM 110. Crankshaft 62 and motor 130 can be connected to one or multiple wheels 140 to power an appurtenant vehicle, for example. Hybrid powertrain 100 can further comprises a HICE 10 heater 150 comprising a resistor 151 capable of receiving electrical power from the PEM 110 or ESD 120 and converting electrical power to heat. Heat from the resistor 151 is transferred to coolant 152 which circulates through a HICE 10 coolant circuit 7, which is illustrated schematically for the sake of clarity. For example, coolant circuit 7 may directly cool the engine block 12, cylinder head 11, piston 20, or other aspects of HICE 10. During HICE 10 cold-starts, heater 150 can be used to quickly heat components thereof, for example.

PEM 110 includes a plurality of controllable power inverters including power transistors configured and controlled to transform electric power between alternating electrical current and direct electrical current. Electric power is transferred between the PEM 110, the HICE 10, the ESD 120, and the motor 130 via electrical buses configured to handle appropriate voltage loads. The motor/generator 130 converts electrical power to mechanical power and converts mechanical power to electrical power that can be stored in the ESD 120. The motor/generator 130 operates as a motor by using electrical power to generate mechanical power in the form of tractive torque to drive one or more wheels 140, for example. The motor/generator 130 operates as a generator by converting mechanical power (i.e., recuperates vehicle kinetic energy) in the form of tractive torque from vehicle wheel 140 braking to electrical power that can be stored in the ESD 120, for example. The ESD 120 can comprise a battery (e.g., a plurality of lithium-ion battery cells connected in series and/or parallel), capacitor, or a capacitor-assisted battery, for example. A controller 101 can be operably connected to PEM 110, ESD 120, generator/motor 130, and HICE 10.

The hybrid powertrain 100 offers numerous advantages. In some embodiments, a standard ICE may be converted to a HICE 10 by inserting the disclosed cylinder liners 40 into the cylinders thereof, and forming the required electrical connections as disclosed herein. Accordingly, HICE 10 can comprise a HICE which was converted from a standard ICE. In operation, each cylinder 13 and appurtenant piston 20 can generate electrical energy via combustion-induced movement of the piston head 30, or utilize electrical energy (e.g., received from the ESD 120) to move the piston head 30 within the cylinder 13. During combustion, the instantaneous position of each cylinder head can be determined by the controller 101 using an electrical signal (e.g., current or voltage feedback) generated by the induction coil. Accordingly, other piston 20 position-sensing aspects may be rendered superfluous and eliminated. Similarly, electrical power may be delivered to each of the induction coils 45 to drive each appurtenant piston 20 in order to start the HICE 10. Accordingly, HICE 10 starters may be rendered superfluous and eliminated.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A cylinder liner for a hybrid internal combustion engine (HICE), the cylinder liner comprising:
a tubular body comprising a non-ferromagnetic material having a height, a thickness defined by an inner diameter and an outer diameter, and an outer contour configured to correspond to an inner contour of an engine block cylinder bore; and
an induction coil encased within the non-ferromagnetic material between the inner diameter and the outer diameter of the tubular body.

2. The cylinder liner of claim 1, wherein the non-ferromagnetic material comprises a ceramic material.

3. The cylinder liner of claim 2, wherein the ceramic material comprises a ceria-stabilized zirconia.

4. The cylinder liner of claim 1, wherein the non-ferromagnetic material in direct contact with the induction coil is further non-electrically conductive.

5. A hybrid internal combustion engine (HICE) comprising:
an engine block defining one or more cylinder bores;
a cylinder liner disposed within each of the one or more cylinder bores, each cylinder liner comprising:
a tubular body comprising a non-ferromagnetic material having a height and a thickness defined by an inner wall and an outer wall, wherein the outer wall forms a contour configured to correspond to an inner contour of its respective cylinder bore, and
an induction coil encased within the non-ferromagnetic material between the inner wall and the outer wall of the tubular body; and
a piston having a head disposed within each of the one or more cylinder liners and comprising a permanent magnet.

6. The HICE of claim 5, wherein the non-ferromagnetic material comprises a ceramic material.

7. The HICE of claim 5, wherein combustion occurs in each cylinder at least partially within a volume defined the induction coil thereof.

8. The HICE of claim 5, wherein each of the one or more pistons are coupled to a crankshaft.

9. The HICE of claim 5, wherein a height of the induction coil extends above a top dead center position of the permanent magnet and below a bottom dead center position of the permanent magnet.

10. The HICE of claim 5, wherein the HICE was converted from an internal combustion engine by introducing each of the one or more cylinder liners into one or more of the cylinder bores.

11. The HICE of claim 5, wherein each piston can be reciprocated within its appurtenant cylinder via electrical power received by the induction coil appurtenant to each cylinder.

12. The HICE of claim 5, wherein combustion-induced reciprocation of each piston head repeatedly transports its permanent magnet across at least a portion of a height of the induction coil of the appurtenant cylinder liner and generates electrical energy.

13. The HICE of claim 5, wherein the HICE can be started by delivering electrical power to each of the induction coils.

14. A hybrid powertrain of a vehicle, comprising:
an electrical energy storage device;
a hybrid internal combustion engine (HICE) comprising:
an engine block defining one or more cylinder bores;
a cylinder liner disposed within each of the one or more cylinder bores, each cylinder liner comprising:
a tubular body comprising a non-ferromagnetic material having a height and a thickness defined by an inner wall and an outer wall, wherein the outer wall forms a contour configured to correspond to an inner contour of its respective cylinder bore, and
an induction coil encased within the non-ferromagnetic material between the inner wall and the outer wall of the tubular body;
a piston having a head disposed within each of the one or more cylinder liners and comprising a permanent magnet, wherein combustion-induced reciprocation of the piston head repeatedly transports the permanent magnet across at least a portion of the height of the induction coil and generates electrical energy; and
a power electronics module configured to transfer the generated electrical energy between each of the one or more cylinder liners and the energy storage device.

15. The hybrid powertrain of claim 14, further comprising a controller configured to determine the position of a piston within a cylinder based on an electrical signal generated by the induction coil.

16. The hybrid powertrain of claim 14, further comprising a motor/generator electrically connected to the power electronics module and configured to (1) convert electrical power received from the power electronics module to mechanical power in the form of tractive torque that drives one or more wheels, and (2) generate electrical power from wheel braking.

17. The hybrid powertrain of claim 14, wherein each piston can be reciprocated within its appurtenant cylinder via electrical power received by the induction coil appurtenant to each cylinder from the electrical energy storage device.

18. The hybrid powertrain of claim 14, wherein the power electronics module comprises one or more controllable power inverters configured to transform electric power between alternating electrical current and direct electrical current.

19. The hybrid powertrain of claim 14, further comprising a crankshaft mechanically coupled to each of the one or more pistons and capable of translating the reciprocating movement of the one or more pistons to rotational motion.

20. The hybrid powertrain of claim 14, further comprising a HICE heater system including a resistor capable of receiving electrical power, converting the electrical power to heat, and transferring the heat to a coolant which circulates through one or more aspects of the HICE.
